(19) United States
(12) Patent Application Publication
(10) Pub. No.: US 2016/0283390 A1
(43) Pub. Date: Sep. 29, 2016

(54) STORAGE CACHE PERFORMANCE BY USING COMPRESSIBILITY OF THE DATA AS A CRITERIA FOR CACHE INSERTION

(71) Applicant: Intel Corporation, Santa Clara, CA (US)

(72) Inventor: Richard L. Coulson, Portland, OR (US)

(73) Assignee: Intel Corporation, Santa Clara, CA (US)

(21) Appl. No.: 14/672,093

(22) Filed: Mar. 27, 2015

(51) Int. Cl. G06F 12/08

(52) U.S. Cl. CPC G06F 12/0891; G06F 2212/222

(57) ABSTRACT

Methods and apparatus related to improving storage cache performance by using compressibility of the data as a criteria for cache insertion or allocation and deletion are described. In one embodiment, memory stores one or more cache lines corresponding to a compressed version of data (e.g., in response to a determination that the data is compressible). It is determined whether the one or more cache lines are to be retained or inserted in the memory based at least in part on an indication of compressibility of the data. Other embodiments are also disclosed and claimed.

### FIELD

The present disclosure generally relates to the field of electronics. More particularly, some embodiments generally relate to improving storage cache performance by using compressibility of the data as a criteria for cache insertion or allocation.

### BACKGROUND

Generally, data stored in a cache can be accessed many times faster than the same data stored in other types of memory. Generally, as the size of a cache media is increased, the likelihood that data is found in the cache increases (e.g., resulting in a better hit rate). However, growing the size of the cache adds to overall system costs.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIGS. 1 and 4-6 illustrate block diagrams of embodiments of computing systems, which may be utilized to implement various embodiments discussed herein.

FIG. 2 illustrates a block diagram of various components of a solid state drive, according to an embodiment.

FIGS. 3A1, 3A2, 3B1, 3B2, and 3C illustrate flow diagrams of methods according some embodiments.

### DETAILED DESCRIPTION

In the following description, numerous specific details are set forth in order to provide a thorough understanding of various embodiments. However, various embodiments may be practiced without the specific details. In other instances, well-known methods, procedures, components, and circuits have not been described in detail so as not to obscure the particular embodiments. Further, various aspects of embodiments may be performed using various means, such as integrated semiconductor circuits (“hardware”), computer-readable instructions organized into one or more programs (“software”), or some combination of hardware and software. For the purposes of this disclosure reference to “logic” shall mean either hardware, software, firmware, or some combination thereof.

As discussed above, utilizing a cache can be beneficial to performance. To this end, storage caches are widely used. For example, Solid State Drives (SSDs) may be used as the cache media. In general, all things being equal, the hit rate of the cache will grow as the size of the cache media grows. Therefore, some cache implementations using SSDs may use hardware compression in the SSD to compress data so that more data fits into the cache, resulting in an improved cache hit rate.

To this end, some embodiments relate to improving storage cache performance by using compressibility of the data as a criteria for cache insertion or allocation. To efficiently use a cache, a decision is made whether a piece of data should be cached (or evicted from the cache). This decision (also referred to herein as “cache insertion” or “cache allocation”) is aimed at ensuring that the data being cached is likely to be accessed in the (e.g., relatively near) future and that the limited space in the cache media is only used for frequently accessed data. Hence, whether some piece of data is cached (or evicted from the cache) can be a critical decision in cache utilization efficiency.

More specifically, one embodiment improves the cache hit rate of storage caches that utilize data compressing non-volatile memory (e.g., SSDs) by giving preference to data (e.g., in a cache line or other granularity of cache storage media) that has higher compressibility as a factor in cache policy decisions (or when data is cached or evicted from the cache). Previously, this was not possible because there was no way for the cache policy logic/software in the host to know the compressibility of the data on a cache line by cache line basis (or other cache granularity). Part of the optimization (that can be implemented in various non-volatile memory such as those discussed herein) includes a feature in the compression process where the host logic/software is explicitly given information regarding the compressibility of each Input/Output (JO) data, e.g., as it is written (or prior to writing the data) to the cache media. Therefore, cache policy logic/software in the host (or a server) can explicitly know the compressibility of each cache line of data, even though the actual compression is performed by hardware in the non-volatile memory device (e.g., SSD) itself. The cache policy logic/software then can give preference to data that is more compressible; thus, increasing the overall compressibility of the data in the cache. Hence, the cache can hold more cache lines than it would have if compressibility was not used as a factor, and therefore, all other factors being equal, the hit rate of the cache will improve. Thus compressibility of the data in a cache line is used to augment traditional factors (sequentiality, process ID, size, file type to name a few) used to decide whether or not to move storage data into the cache or remove storage data from the cache.

Furthermore, even though some embodiments are discussed with reference to SSDs (e.g., including NAND and/or NOR type of memory cells), embodiments are not limited to SSDs and non-volatile memory of any type (in a format other than SSD but still usable for storage) may be used. The storage media (whether used in SSD format or otherwise) can be any type of storage media including, for example, one or more of: nanowire memory, Ferro-electric transistor random access memory (FeTRAM), magnetoresistive random access memory (MRAM), flash memory, Spin Torque Transfer Random Access Memory (STTRAM), Resistive Random Access Memory, byte addressable 3-Dimensional Cross Point Memory, PCM (Phase Change Memory), etc. Also, any type of Random Access Memory (RAM) such as Dynamic RAM (DRAM), backed by battery or capacitance to retain the data, may be used. Hence, even volatile memory capable of retaining data during power failure or power disruption (e.g., backed by battery or capacitance) may be used for the storage cache.

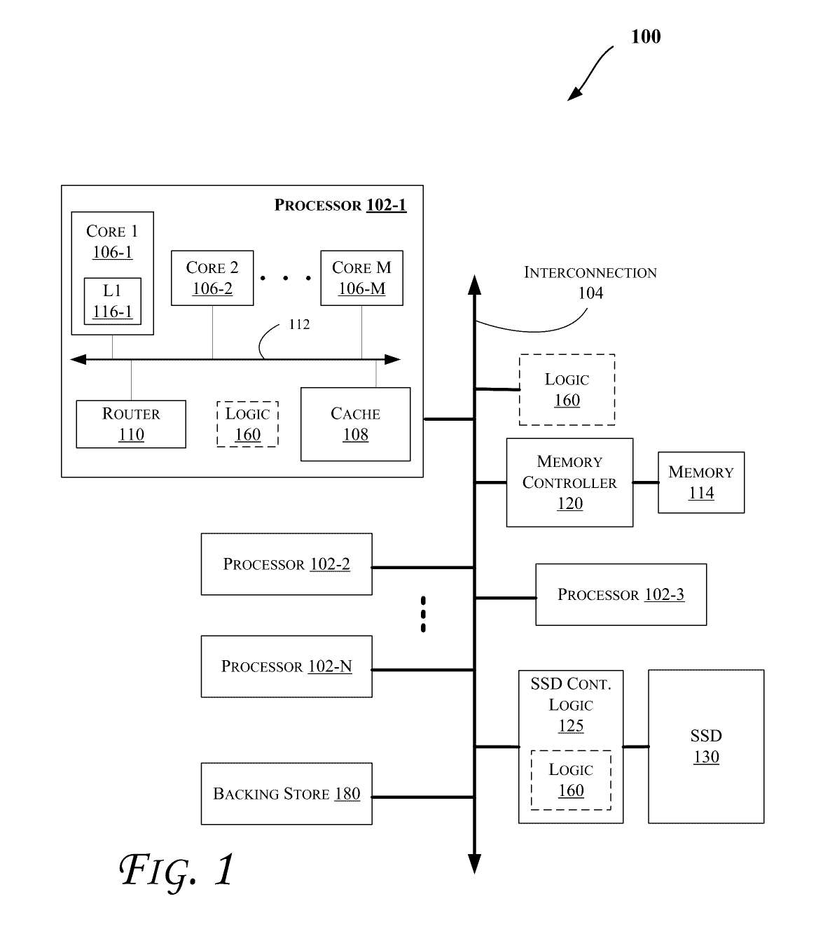

The techniques discussed herein may be provided in various computing systems (e.g., including a non-mobile computing device such as a desktop, workstation, server, rack system, etc. and a mobile computing device such as a smartphone, tablet, UMPC (Ultra-Mobile Personal Computer), laptop computer, Ultrabook™ computing device, smart watch, smart glasses, smart bracelet, etc.), including those discussed with reference to FIGS. 1-6. More particularly, FIG. 1 illustrates a block diagram of a computing system 100, according to an embodiment. The system 100 may include one or more processors 102-1 through 102-N (generally referred to herein as “processors 102” or “processor 102”). The processors 102 may communicate via an interconnection or bus 104. Each processor may include various components some of which are only discussed with reference to processor 102-1 for clarity. Accordingly, each of the remaining processors 102-2 through 102-N may include the same or similar components discussed with reference to the processor 102-1.

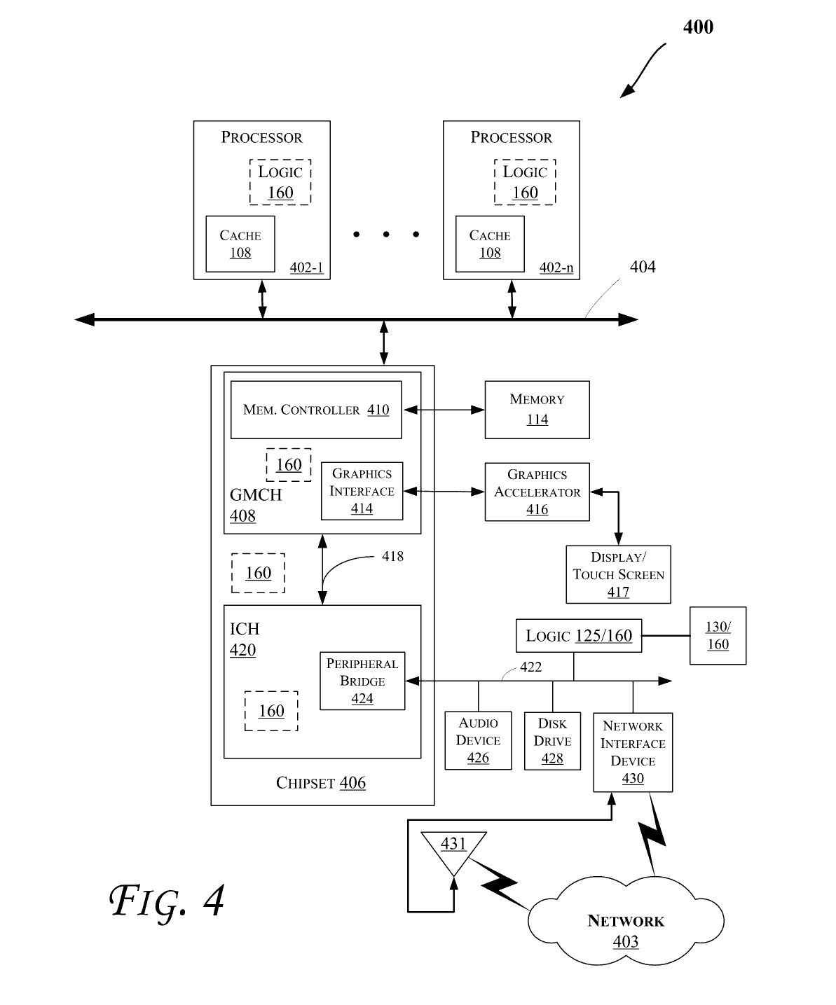

In an embodiment, the processor 102-1 may include one or more processor cores 106-1 through 106-M (referred to herein as “cores 106,” or more generally as “core 106”), a processor cache 108 (which may be a shared cache or a private cache in various embodiments), and/or a router 110. The processor cores 106 may be implemented on a single integrated circuit (IC) chip. Moreover, the chip may include one or more shared and/or private caches (such as processor cache 108), buses or interconnections (such as a bus or interconnection 112), logic 120, memory controllers (such as those discussed with reference to FIGS. 4-6), or other components.

In one embodiment, the router 110 may be used to communicate between various components of the processor 102-1 and/or system 100. Moreover, the processor 102-1 may include more than one router 110. Furthermore, the multitude of routers 110 may be in communication to enable data routing between various components inside or outside of the processor 102-1.

The processor cache 108 may store data (e.g., including instructions) that are utilized by one or more components of the processor 102-1, such as the cores 106. For example, the processor cache 108 may locally cache data stored in a memory 114 for faster access by the components of the processor 102. As shown in FIG. 1, the memory 114 may be in communication with the processors 102 via the interconnection 104. In an embodiment, the processor cache 108 (that may be shared) may have various levels, for example, the processor cache 108 may be a mid-level cache and/or a last-level cache (LLC). Also, each of the cores 106 may include a level 1 (L1) processor cache (116-1) (generally referred to herein as “L1 processor cache 116”). Various components of the processor 102-1 may communicate with the processor cache 108 directly, through a bus (e.g., the bus 112), and/or a memory controller or hub.

As shown in FIG. 1, memory 114 may be coupled to other components of system 100 through a memory controller 120. Memory 114 includes volatile memory and may be interchangeably referred to as main memory. Even though the memory controller 120 is shown to be coupled between the interconnection 104 and the memory 114, the memory controller 120 may be located elsewhere in system 100. For example, memory controller 120 or portions of it may be provided within one of the processors 102 in some embodiments.

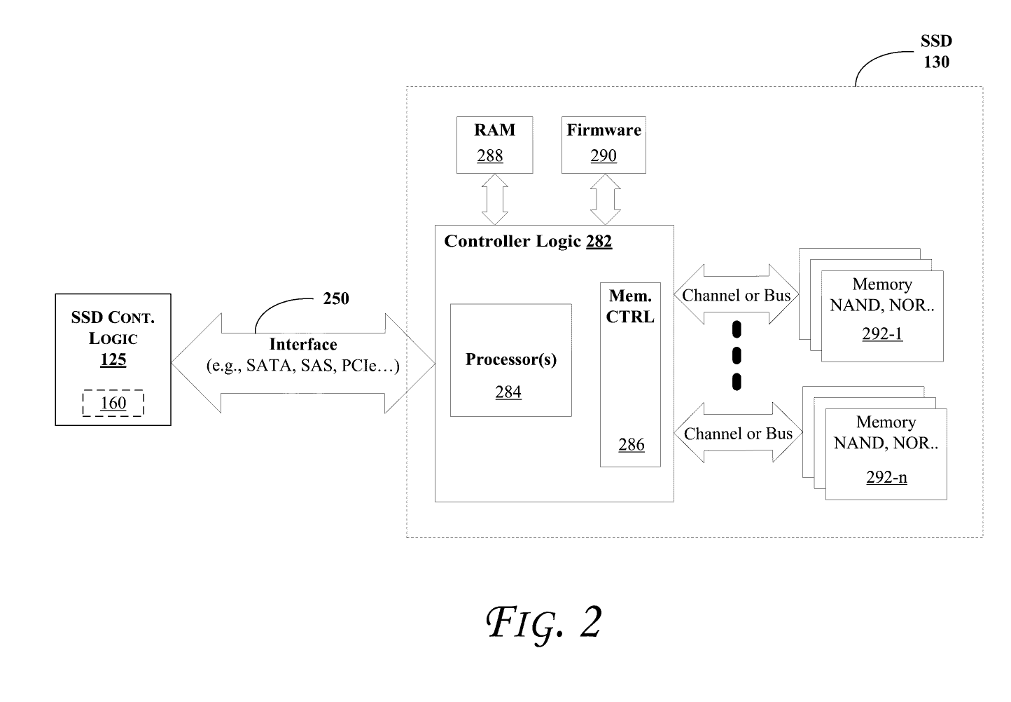

System 100 also includes Non-Volatile (NV) storage (or Non-Volatile Memory (NVM)) device such as an SSD 130 coupled to the interconnect 104 via SSD controller logic 125. Hence, logic 125 may control access by various components of system 100 to the SSD 130. Furthermore, even though logic 125 is shown to be directly coupled to the interconnection 104 in FIG. 1, logic 125 can alternatively communicate via a storage bus/interconnect (such as the SATA (Serial Advanced Technology Attachment) bus, Peripheral Component Interconnect (PCI) (or PCI express (PCIe) interface), etc.) with one or more other components of system 100 (for example where the storage bus is coupled to interconnect 104 via some other logic like a bus bridge, chipset (such as discussed with reference to FIGS. 2 and 4-6), etc.). Additionally, logic 125 may be incorporated into memory controller logic (such as those discussed with reference to FIGS. 4-6) or provided on a same Integrated Circuit (IC) device in various embodiments (e.g., on the same IC device as the SSD 130 or in the same enclosure as the SSD 130).

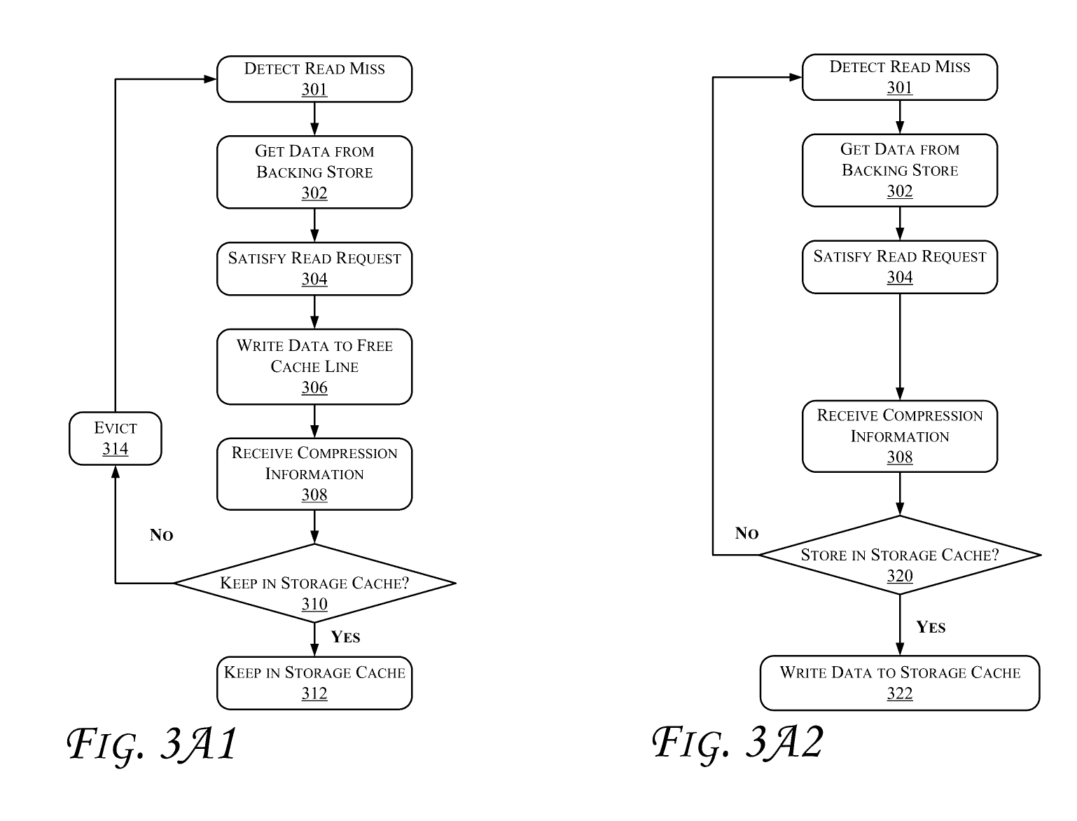

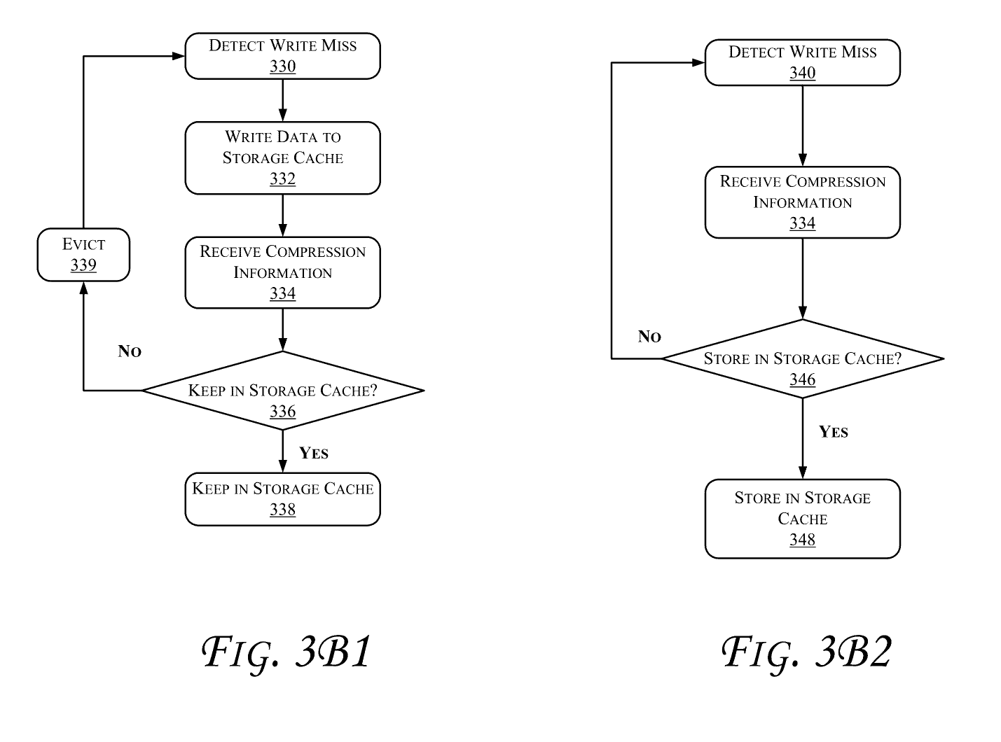

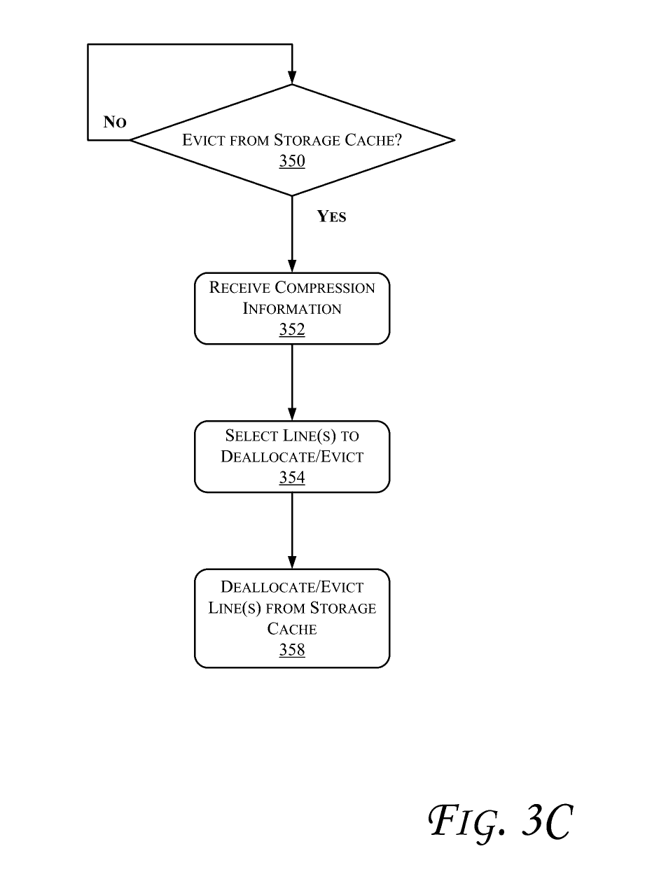

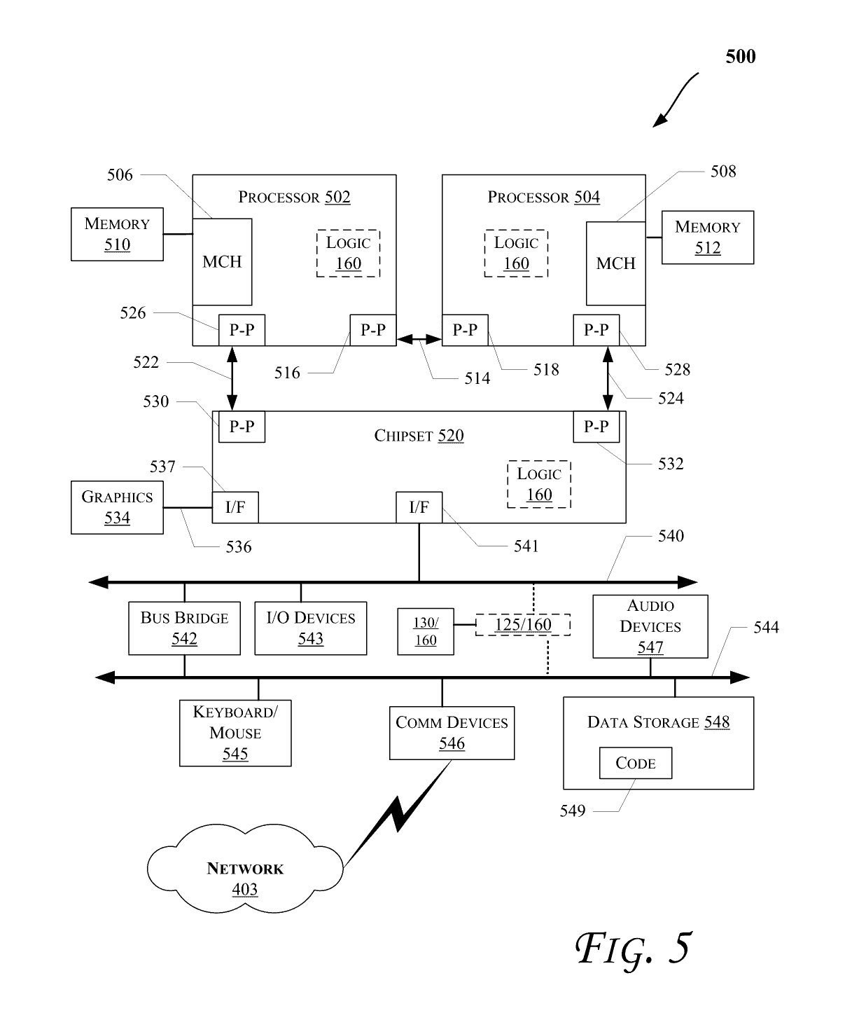

As shown in FIG. 1, system 100 also includes a backing store 180 which may be a storage device that is relatively slower than a storage cache (such as SSD 130). Hence backing store 180 may include a hard disk drive, such as disk drive 428 of FIG. 4, data storage 548 of FIG. 5, or more generally any other storage device that is slower than the storage cache. Moreover, the storage cache (e.g., SSD 130 or another storage device discussed herein, such as NVM or non-NVM device with power backup) may be used to cache data stored in the backing store 180, as will be further discussed herein, e.g., with reference to FIGS. 3A1 to FIG. 3C.

Furthermore, logic 125 and/or SSD 130 may be coupled to one or more sensors (not shown) to receive information (e.g., in the form of one or more bits or signals) to indicate the status of or values detected by the one or more sensors. These sensor(s) may be provided proximate to components of system 100 (or other computing systems discussed herein such as those discussed with reference to other figures including 4-6, for example), including the cores 106, interconnections 104 or 112, components outside of the processor 102, SSD 130, SSD bus, SATA bus, logic 125, etc., to sense variations in various factors affecting power/thermal behavior of the system/platform, such as temperature, operating frequency, operating voltage, power consumption, and/or inter-core communication activity, etc.

As illustrated in FIG. 1, system 100 may include cache logic 160, which can be located in various locations in system 100 (such as those locations shown, including coupled to interconnect 104, inside processor 102, etc.). As discussed herein, logic 160 improves storage cache performance by using compressibility of the data as a criteria for cache insertion.

FIG. 2 illustrates a block diagram of various components of an SSD, according to an embodiment. Logic 160 may be located in various locations in system 100 of FIG. 1 as discussed, as well as inside SSD controller logic 125. While SSD controller logic 125 may facilitate communication between the SSD 130 and other system components via an interface 250 (e.g., SATA, SAS, PCIe, etc.), a controller logic 282 facilitates communication between logic 125 and components inside the SSD 130 (or communication between components inside the SSD 130). As shown in FIG. 2, controller logic 282 includes one or more processor cores or processors 284 and memory controller logic 286, and is coupled to Random Access Memory (RAM) 288, firmware storage 290, and one or more memory modules or dies 292-1 to 292-n (which may include NAND flash, NOR flash, or other types of non-volatile memory). Memory modules 292-1 to 292-n are coupled to the memory controller logic 286 via one or more memory channels or busses. One or more of the operations discussed with reference to FIGS. 1-6 may be performed by one or more of the components of FIG. 2, e.g., processors 284 and/or controller 282 may compress/decompress (or otherwise cause compression/decompression) of data written to or read from memory modules 292-1 to 292-n. Also, one or more of the operations of FIGS. 1-6 may be programmed into the firmware 290. Furthermore, in some embodiments, a hybrid drive may be used instead of the SSD 130 (where a plurality of memory modules/media 292-1 to 292-n is present such as a hard disk drive, flash memory, or other types of non-volatile memory discussed herein). In embodiments using a hybrid drive, logic 160 may be present in the same enclosure as the hybrid drive.

FIGS. 3A1 to C illustrate flow diagrams of methods according to some embodiments. More particularly, FIGS. 3A1 and 3A2 illustrate methods to address two types of read misses. FIGS. 3B1 and 3B2 illustrate methods to address two types of write misses. FIG. 3C illustrates a method to provide free space in a storage cache, according to an embodiment. The methods shown in FIGS. 3A1 to C are intended to improve storage cache performance by using compressibility of the data as a criteria for cache allocation, according to some embodiments. In some embodiments, one or more components (such as logic 160) of FIGS. 1-2 and/or 4-6 perform one or more operations of FIGS. 3A1-C.

Referring to FIGS. 1-3A1, at an operation 302, in response to detection of a read miss at operation 301 (where a “read miss” generally refers to an indication that some requested data is absent from a storage cache (e.g., SSD 130 or other storage cache such as those discussed herein)), the requested data is obtained from a backing store (e.g., backing store 180). At operation 304, the read request is satisfied (i.e., the requested data is provided to the requesting agent). At operation 306, the requested data is stored in one or more free cache lines of the storage cache. At an operation 308, compression information regarding data written at operation 306 is received. The compression information may include an indication of how compressible the data is (or alternatively, the size of the compressed version of data versus uncompressed version of the data). Using this compression information as one factor, operation 310 determines whether to keep the data in the one or more cache entries/lines of the storage cache. Thus, compressibility of the data (per compression information of operation 308) in a cache line is used to augment traditional factors (sequentiality, process ID, request size, and/or file type to name a few) used to decide whether to keep the data in the storage cache at operation 312 or remove the data from the storage cache at operation 314.

Referring to FIGS. 1-3A2, method of FIG. 3A2 deals with a different type of read miss than the method of FIG. 3A1 in that the method of FIG. 3A2 does not write the data to free cache line(s) as is done at operation 306 of FIG. 3A1. Instead, the method of FIG. 3A2 determines whether to store the requested data in the storage cache at operation 320. This decision uses the compressibility of the data of operation 308 as one factor to determine whether to store the data in the one or more cache entries/lines of the storage cache. Thus, compressibility of the data (per compression information of operation 308) in a cache line is used to augment traditional factors (sequentiality, process ID, request size, and/or file type to name a few) used to decide whether to write the data in the storage cache at operation 322.

Referring to FIGS. 1-3B1, at an operation 332, in response to detection of a write miss at operation 330 (where a “write miss” generally refers to an indication that the write data is absent from the storage cache). At operation 332, the data is written to the storage cache. At operation 334, compression information regarding data written at operation 332 is received. The compression information may include an indication of how compressible the data is (or alternatively, the size of the compressed version of data versus uncompressed version of the data). Using this compression information as one factor, operation 336 determines whether to keep the data in the one or more cache entries/lines of the storage cache. Thus, compressibility of the data (per compression information of operation 308) in a cache line is used to augment traditional factors (sequentiality, process ID, request size, and/or file type to name a few) used to decide whether to keep the data in the storage cache at operation 338 or remove the data from the storage cache at operation 339.

Referring to FIGS. 1-3B2, method of FIG. 3B2 deals with a different type of write miss than the method of FIG. 3B1 in that the method of FIG. 3B2 does not write the data to free cache line(s) as is done at operation 332 of FIG. 3B1. Instead, the method of FIG. 3B2 determines whether to store the data in the storage cache at operation 346. This decision uses the compressibility of the data of operation 338 as one factor to determine whether to store the data in the one or more cache entries/lines of the storage cache. Thus, compressibility of the data (per compression information of operation 346) in a cache line is used to augment traditional factors (sequentiality, process ID, request size, and/or file type to name a few) used to decide whether to write data in the storage cache at operation 348.

FIG. 3C illustrates a flow diagram of a method to evict or deallocate one or more cache lines from a storage cache, according to an embodiment. In some embodiments, the method of FIG. 3C is used to perform the operations 314 and/or 339 discussed with reference to FIGS. 3A1 and 3B1, respectively. Moreover, deletion/deallocation/eviction from a storage cache usually happens after operations associated with satisfying a read miss or a write miss (such as those discussed with reference to FIGS. 3A1 to 3B2). The cache eviction operation generally occurs if some cache “fullness” or “free space” threshold is reached, or otherwise if it is determined that some data stored in the storage cache is no longer needed to be cached as in operations 314 and/or 339. To this end, at operation 350, once it is determined that some cached data (e.g., in one or more cache lines) is to be deleted, operation 352 receives compression information regarding the one or more cache lines to be evicted as one factor to determine whether to evict the cache line(s) at operation 354. Hence, the selection operation at 354 is based on compressibility of the data (per compression information of operation 352) that augments traditional factors (sequentiality, process ID, request size, and/or file type to name a few) used to decide whether to delete the selected line(s) from the storage cache at operation 358.

Furthermore, the insertion decision would be yes/no for the data currently being read or written. The deletion would be made based on factors like LRU (Least Recently Used) plus compressibility information and would be in response to the need for space, and in this case, logic would search for the “Best” cache line to delete. In various embodiments, the data may be cached in a dedicated cache (not shown) and/or in NVM (such as memory cells 292, SSD 130, etc.). Also, the methods of FIGS. 3A1-3C may be performed in response to a read or a write operation directed at a backing store (such as the backing store 180, the disk drive 428 of FIG. 4, data storage 548 of FIG. 5, or another storage device that is slower than the SSD 130 used as a storage cache (including, for example, a slower SSD or NVM) and/or based on periodical schedule (e.g., in response to expiration of a timer). The periodical schedule may be used for deallocation from cache and not usually not for the decision to insert/allocate in the cache.

Accordingly, an embodiment improves the effectiveness of storage caches by using the compressibility of the data in a “line” of the cache to be a factor in the algorithms/policies deciding when to insert/allocate/retain a line in the cache and when to delete/evict a line from the cache. Preference can be given to cache lines that are more compressible; thus, increasing the number of lines the cache holds. Hence, the hit rate, and the overall performance of the storage subsystem will improve. In some embodiments, there is an assumption that there is either no correlation or positive correlation between compressibility and the likelihood of the data being needed in the near future.

In some implementations, when queried, NVM (e.g., SSD 130 and/or logic 160) returns a size that grows/shrinks in proportion to the aggregate compressibility of all the data on the media. When the size grows, additional cache lines can be added to the cache. When the size shrinks, lines are removed from the cache. Hence, some embodiments provide an improved implementation because by using the compressibility of an individual cache line as a criteria, preference can be given to more compressible cache lines as a factor in cache insertion/retention and/or deletion policies, and thus the overall compressibility of the aggregate data can be improved, resulting in more cache lines being stored.

Moreover, in an embodiment, host caching policies (e.g., implemented in processors 102/402/502/620/630 of FIGS. 1-6) may know the size of the compressed cache line for their placement algorithm/logic (e.g., logic 160). This information may be the same as cache line compressibility discussed with reference to FIGS. 3A1-3C. Furthermore, some embodiments can be used in storage caches to improve performance, so this improvement is directly marketable. Alternatively, it can be used as a way to use a smaller and/or lower cost NVM/SSD to achieve similar performance as a larger, more expensive cache.

FIG. 4 illustrates a block diagram of a computing system 400 in accordance with an embodiment. The computing system 400 may include one or more central processing unit(s) (CPUs) 402 or processors that communicate via an interconnection network (or bus) 404. The processors 402 may include a general purpose processor, a network processor (that processes data communicated over a computer network 403), an application processor (such as those used in cell phones, smart phones, etc.), or other types of a processor (including a reduced instruction set computer (RISC) processor or a complex instruction set computer (CISC)). Various types of computer networks 403 may be utilized including wired (e.g., Ethernet, Gigabit, Fiber, etc.) or wireless networks (such as cellular, 3G (Third-Generation Cell-Phone Technology or 3rd Generation Wireless Format (UWCC)), 4G, Low Power Embedded (LPE), etc.). Moreover, the processors 402 may have a single or multiple core design. The processors 402 with a multiple core design may integrate different types of processor cores on the same integrated circuit (IC) die. Also, the processors 402 with a multiple core design may be implemented as symmetrical or asymmetrical multiprocessors.

In an embodiment, one or more of the processors 402 may be the same or similar to the processors 102 of FIG. 1. For example, one or more of the processors 402 may include one or more of the cores 106 and/or processor cache 108. Also, the operations discussed with reference to FIGS. 1-3C may be performed by one or more components of the system 400.

A chipset 406 may also communicate with the interconnection network 404. The chipset 406 may include a graphics and memory control hub (GMCH) 408. The GMCH 408 may include a memory controller 410 (which may be the same or similar to the memory controller 120 of FIG. 1 in an embodiment) that communicates with the memory 114. The memory 114 may store data, including sequences of instructions that are executed by the CPU 402, or any other device included in the computing system 400. Also, system 400 includes logic 125, SSD 130, and/or logic 160 (which may be coupled to system 400 via bus 422 as illustrated, via other interconnects such as 404, where logic 125 is incorporated into chipset 406, etc. in various embodiments). In one embodiment, the memory 114 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk drive, flash, etc., including any NVM discussed herein. Additional devices may communicate via the interconnection network 404, such as multiple CPUs and/or multiple system memories.

The GMCH 408 may also include a graphics interface 414 that communicates with a graphics accelerator 416. In one embodiment, the graphics interface 414 may communicate with the graphics accelerator 416 via an accelerated graphics port (AGP) or Peripheral Component Interconnect (PCI) (or PCI express (PCIe) interface). In an embodiment, a display 417 (such as a flat panel display, touch screen, etc.) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display 417.

A hub interface 418 may allow the GMCH 408 and an input/output control hub (ICH) 420 to communicate. The ICH 420 may provide an interface to I/O devices that communicate with the computing system 400. The ICH 420 may communicate with a bus 422 through a peripheral bridge (or controller) 424, such as a peripheral component interconnect (PCI) bridge, a universal serial bus (USB) controller, or other types of peripheral bridges or controllers. The bridge 424 may provide a data path between the CPU 402 and peripheral devices. Other types of topologies may be utilized. Also, multiple buses may communicate with the ICH 420, e.g., through multiple bridges or controllers. Moreover, other peripherals in communication with the ICH 420 may include, in various embodiments, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 422 may communicate with an audio device 426, one or more disk drive(s) 428, and a network interface device 430 (which is in communication with the computer network 403, e.g., via a wired or wireless interface). As shown, the network interface device 430 may be coupled to an antenna 431 to wirelessly (e.g., via an Institute of Electrical and Electronics Engineers (IEEE) 802.11 interface (including IEEE 802.11a/b/g/n/ac, etc.), cellular interface, 3G, 4G, LPE, etc.) communicate with the network 403. Other devices may communicate via the bus 422. Also, various components (such as the network interface device 430) may communicate with the GMCH 408 in some embodiments. In addition, the processor 402 and the GMCH 408 may be combined to form a single chip. Furthermore, the graphics accelerator 416 may be included within the GMCH 408 in other embodiments.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

FIG. 5 illustrates a computing system 500 that is arranged in a point-to-point (PtP) configuration, according to an embodiment. In particular, FIG. 5 shows a system where processors, memory, and input/output devices are interconnected by a number of point-to-point interfaces. The operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to enable communication with memories 510 and 512. The memories 510 and/or 512 may store various data such as those discussed with reference to the memory 114 of FIGS. 1 and/or 4. Also, MCH 506 and 508 may include the memory controller 120 in some embodiments. Furthermore, system 500 includes logic 125, SSD 130, and/or logic 160 (which may be coupled to system 500 via bus 540/544 such as illustrated, via other point-to-point connections to the processor(s) 502/504 or chipset 520, where logic 125 is incorporated into chipset 520, etc. in various embodiments).

In an embodiment, the processors 502 and 504 may be one of the processors 402 discussed with reference to FIG. 4. The processors 502 and 504 may exchange data via a point-to-point (PtP) interface 514 using PtP interface circuits 516 and 518, respectively. Also, the processors 502 and 504 may each exchange data with a chipset 520 via individual PtP interfaces 522 and 524 using point-to-point interface circuits 526, 528, 530, and 532. The chipset 520 may further exchange data with a high-performance graphics circuit 534 via a high-performance graphics interface 536, e.g., using a PtP interface circuit 537. As discussed with reference to FIG. 4, the graphics interface 536 may be coupled to a display device (e.g., display 417) in some embodiments.

In one embodiment, one or more of the cores 106 and/or processor cache 108 of FIG. 1 may be located within the processors 502 and 504 (not shown). Other embodiments, however, may exist in other circuits, logic units, or devices within the system 500 of FIG. 5. Furthermore, other embodiments may be distributed throughout several circuits, logic units, or devices illustrated in FIG. 5.

The chipset 520 may communicate with a bus 540 using a PtP interface circuit 541. The bus 540 may have one or more devices that communicate with it, such as a bus bridge 542 and I/O devices 543. Via a bus 544, the bus bridge 542 may communicate with other devices such as a keyboard/mouse 545, communication devices 546 (such as modems, network interface devices, or other communication devices that may communicate with the computer network 403, as discussed with reference to network interface device 430 for example, including via antenna 431), audio I/O device, and/or a data storage device 548. The data storage device 548 may store code 549 that may be executed by the processors 502 and/or 504.

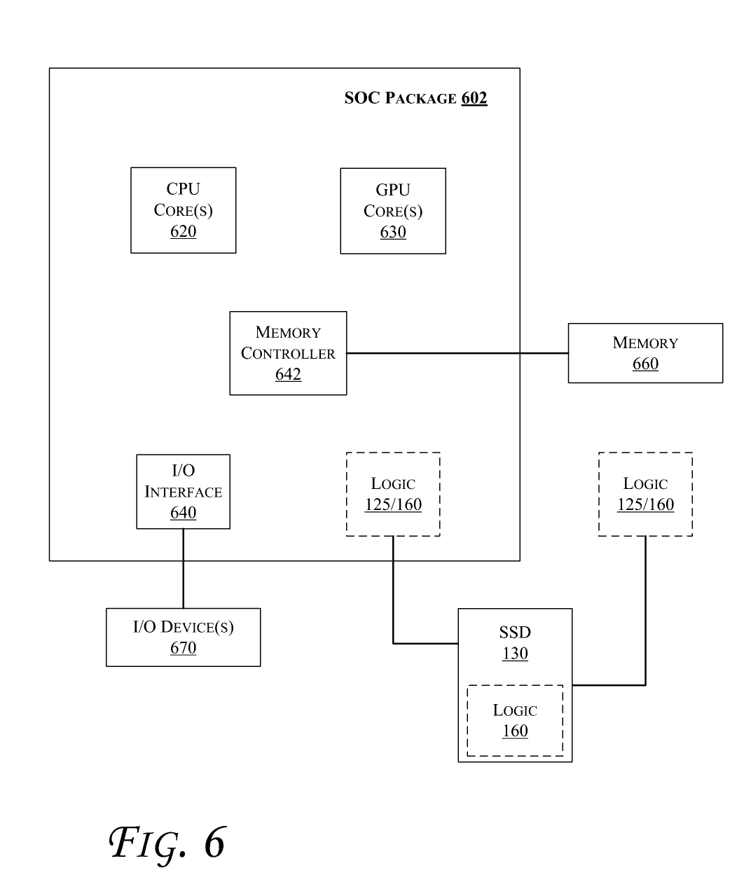

In some embodiments, one or more of the components discussed herein can be embodied as a System On Chip (SOC) device. FIG. 6 illustrates a block diagram of an SOC package in accordance with an embodiment. As illustrated in FIG. 6, SOC 602 includes one or more Central Processing Unit (CPU) cores 620, one or more Graphics Processor Unit (GPU) cores 630, an Input/Output (I/O) interface 640, and a memory controller 642. Various components of the SOC package 602 may be coupled to an interconnect or bus such as discussed herein with reference to the other figures. Also, the SOC package 602 may include more or less components, such as those discussed herein with reference to the other figures. Further, each component of the SOC package 620 may include one or more other components, e.g., as discussed with reference to the other figures herein. In one embodiment, SOC package 602 (and its components) is provided on one or more Integrated Circuit (IC) die, e.g., which are packaged onto a single semiconductor device.

As illustrated in FIG. 6, SOC package 602 is coupled to a memory 660 (which may be similar to or the same as memory discussed herein with reference to the other figures) via the memory controller 642. In an embodiment, the memory 660 (or a portion of it) can be integrated on the SOC package 602.

The I/O interface 640 may be coupled to one or more I/O devices 670, e.g., via an interconnect and/or bus such as discussed herein with reference to other figures. I/O device(s) 670 may include one or more of a keyboard, a mouse, a touchpad, a display, an image/video capture device (such as a camera or camcorder/video recorder), a touch screen, a speaker, or the like. Furthermore, SOC package 602 may include/integrate the logic 125 in an embodiment. Alternatively, the logic 125 may be provided outside of the SOC package 602 (i.e., as a discrete logic).

The following examples pertain to further embodiments. Example 1 includes an apparatus comprising: memory to store one or more cache lines corresponding to a compressed version of data in response to a determination that the data is compressible; and logic to determine whether the one or more cache lines are to be retained or inserted in the memory based at least in part on an indication of compressibility of the data. Example 2 includes the apparatus of example 1, wherein the one or more cache lines are to be stored in the memory prior to the determination of whether the one or more cache lines are to be retained in the memory. Example 3 includes the apparatus of example 1, wherein the one or more cache lines are to be stored in the memory after the determination of whether the one or more cache lines are to be retained in the memory. Example 4 includes the apparatus of example 1, comprising logic to determine whether to remove the one or more cache lines. Example 5 includes the apparatus of example 1, comprising logic to determine whether to remove the one or more cache lines based at least in part on the indication of compressibility of the data. Example 6 includes the apparatus of example 1, wherein the compressibility of the data is to be determined based at least in part on a size of an uncompressed version of the data and a size of the compressed version of the data. Example 7 includes the apparatus of example 1, wherein the memory is to include non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory. Example 8 includes the apparatus of example 1, wherein an SSD is to comprise the memory and the logic. Example 9 includes the apparatus of example 1, wherein the memory is to store uncompressed data.

Example 10 includes a method comprising: storing one or more cache lines, corresponding to a compressed version of data, in memory in response to a determination that the data is compressible; and determining whether the one or more cache lines are to be retained or inserted in the memory based at least in part on an indication of compressibility of the data. Example 11 includes the method of example 10, further comprising storing the one or more cache lines in the memory prior to the determination of whether the one or more cache lines are to be retained in the memory. Example 12 includes the method of example 10, further comprising storing the one or more cache lines in the memory after the determination of whether the one or more cache lines are to be retained in the memory. Example 13 includes the method of example 10, further comprising determining whether to remove the one or more cache lines. Example 14 includes the method of example 10, further comprising determining whether to remove the one or more cache lines based at least in part on the indication of compressibility of the data. Example 15 includes the method of example 10, further comprising determining the compressibility of the data based at least on a size of an uncompressed version of the data and a size of the compressed version of the data. Example 16 includes the method of example 9, further comprising storing uncompressed data in the memory. Example 17 includes the method of example 10, wherein the memory includes non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory.

Example 18 includes a system comprising: memory; and at least one processor core to access the memory; the memory to store one or more cache lines corresponding to a compressed version of data in response to a determination that the data is compressible; logic to determine whether the one or more cache lines are to be retained or inserted in the memory at least in part based on an indication of compressibility of the data. Example 19 includes the system of example 18, wherein the one or more cache lines are to be stored in the memory prior to the determination of whether the one or more cache lines are to be retained in the memory. Example 20 includes the system of example 18, wherein the one or more cache lines are to be stored in the memory after the determination of whether the one or more cache lines are to be retained in the memory. Example 21 includes the system of example 18, comprising logic to determine whether to remove the one or more cache lines based at least in part on the indication of compressibility of the data. Example 22 includes the system of example 18, wherein the compressibility of the data is to be determined based at least in part on a size of an uncompressed version of the data and a size of the compressed version of the data. Example 23 includes the system of example 18, wherein the memory is to store uncompressed data. Example 24 includes the system of example 18, wherein the memory is to include non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory. Example 25 includes the system of example 18, wherein an SSD is to comprise the memory and the logic.

Example 26 includes a computer-readable medium comprising one or more instructions that when executed on a processor configure the processor to perform one or more operations to: store one or more cache lines, corresponding to a compressed version of data, in memory in response to a determination that the data is compressible; and determine whether the one or more cache lines are to be retained or inserted in the memory based at least in part on an indication of compressibility of the data. Example 27 includes the computer-readable medium of example 26, further comprising one or more instructions that when executed on the processor configure the processor to perform one or more operations to store the one or more cache lines in the memory prior to the determination of whether the one or more cache lines are to be retained in the memory. Example 28 includes the computer-readable medium of example 26, further comprising one or more instructions that when executed on the processor configure the processor to perform one or more operations to store the one or more cache lines in the memory after the determination of whether the one or more cache lines are to be retained in the memory.

Example 29 includes an apparatus comprising means to perform a method as set forth in any preceding example. Example 30 comprises machine-readable storage including machine-readable instructions, when executed, to implement a method or realize an apparatus as set forth in any preceding example.

In various embodiments, the operations discussed herein, e.g., with reference to FIGS. 1-6, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-6.

Additionally, such tangible computer-readable media may be downloaded as a computer program product, wherein the program may be transferred from a remote computer (e.g., a server) to a requesting computer (e.g., a client) by way of data signals (such as in a carrier wave or other propagation medium) via a communication link (e.g., a bus, a modem, or a network connection).

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1. An apparatus comprising:
memory to store one or more cache lines corresponding to a compressed version of data in response to a determination that the data is compressible; and
logic to determine whether the one or more cache lines are to be retained or inserted in the memory based at least in part on an indication of compressibility of the data.

2. The apparatus of claim 1, wherein the one or more cache lines are to be stored in the memory prior to the determination of whether the one or more cache lines are to be retained in the memory.

3. The apparatus of claim 1, wherein the one or more cache lines are to be stored in the memory after the determination of whether the one or more cache lines are to be retained in the memory.

4. The apparatus of claim 1, comprising logic to determine whether to remove the one or more cache lines.

5. The apparatus of claim 1, comprising logic to determine whether to remove the one or more cache lines based at least in part on the indication of compressibility of the data.

6. The apparatus of claim 1, wherein the compressibility of the data is to be determined based at least in part on a size of an uncompressed version of the data and a size of the compressed version of the data.

7. The apparatus of claim 1, wherein the memory is to include non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory.

8. The apparatus of claim 1, wherein an SSD is to comprise the memory and the logic.

9. The apparatus of claim 1, wherein the memory is to store uncompressed data.

10. A method comprising:
storing one or more cache lines, corresponding to a compressed version of data, in memory in response to a determination that the data is compressible; and
determining whether the one or more cache lines are to be retained or inserted in the memory based at least in part on an indication of compressibility of the data.

11. The method of claim 10, further comprising storing the one or more cache lines in the memory prior to the determination of whether the one or more cache lines are to be retained in the memory.

12. The method of claim 10, further comprising storing the one or more cache lines in the memory after the determination of whether the one or more cache lines are to be retained in the memory.

13. The method of claim 10, further comprising determining whether to remove the one or more cache lines.

14. The method of claim 10, further comprising determining whether to remove the one or more cache lines based at least in part on the indication of compressibility of the data.

15. The method of claim 10, further comprising determining the compressibility of the data based at least on a size of an uncompressed version of the data and a size of the compressed version of the data.

16. The method of claim 9, further comprising storing uncompressed data in the memory.

17. The method of claim 10, wherein the memory includes non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory.

18. A system comprising:
memory; and
at least one processor core to access the memory;
the memory to store one or more cache lines corresponding to a compressed version of data in response to a determination that the data is compressible;
logic to determine whether the one or more cache lines are to be retained or inserted in the memory at least in part based on an indication of compressibility of the data.

19. The system of claim 18, wherein the one or more cache lines are to be stored in the memory prior to the determination of whether the one or more cache lines are to be retained in the memory.

20. The system of claim 18, wherein the one or more cache lines are to be stored in the memory after the determination of whether the one or more cache lines are to be retained in the memory.

21. The system of claim 18, comprising logic to determine whether to remove the one or more cache lines based at least in part on the indication of compressibility of the data.

22. The system of claim 18, wherein the compressibility of the data is to be determined based at least in part on a size of an uncompressed version of the data and a size of the compressed version of the data.

23. The system of claim 18, wherein the memory is to store uncompressed data.

24. The system of claim 18, wherein the memory is to include non-volatile memory comprising one of: nanowire memory, Ferro-electric transistor random access memory (FeTRAM), magnetoresistive random access memory (MRAM), flash memory, Spin Torque Transfer Random Access Memory (STTRAM), Resistive Random Access Memory, Phase Change Memory (PCM), NAND, 3-Dimensional NAND, and byte addressable 3-Dimensional Cross Point Memory.

25. The system of claim 18, wherein an SSD is to comprise the memory and the logic.
